(19) United States
(12) Patent Application Publication
(10) Pub. No.: US 2025/0242528 A1
(43) Pub. Date: Jul. 31, 2025

(54) MOLDED PRODUCT MANUFACTURING METHOD AND MANUFACTURING APPARATUS

(71) Applicant: CANON KABUSHIKI KAISHA, Tokyo (JP)

(72) Inventors: SHUICHI HASEGAWA, Kanagawa (JP); YUKUO YAMAGUCHI, Tokyo (JP); RYO SATO, Kanagawa (JP); DAIKI YAMAMOTO, Kanagawa (JP); TOMOAKI KAMAGATA, Kanagawa (JP); KAZUNORI IIMURA, Ibaraki (JP); SATOSHI KAYABA, Ibaraki (JP)

(21) Appl. No.: 19/036,208

(22) Filed: Jan. 24, 2025

(30) Foreign Application Priority Data
Jan. 31, 2024 (JP) 2024-012787

(51) Int. Cl. B29C 45/16; B29C 45/00; B29C 45/04

(52) U.S. Cl. CPC B29C 45/1628; B29C 45/0062; B29C 45/045; B29C 2045/0067

(57) ABSTRACT

A molded product manufacturing method includes the steps of: molding a first component and a second component between a first surface and an A surface; molding a third component and a fourth component between the first surface and a B surface and engaging the second component with the first component held on the A surface; welding the first component and the second component to mold a first integral molded product and engaging the fourth component with the third component held on the B surface; and welding the third component and the fourth component to mold a second integral molded product.

### BACKGROUND

### Field

The present disclosure relates to a molded product manufacturing method and a manufacturing apparatus.

### Description of the Related Art

The Specification of European Patent No. 1628819 discloses a manufacturing apparatus including an intermediate mold between a first mold and a second mold. The manufacturing apparatus of the Specification of European Patent No. 1628819 conducts molding with the first mold and the intermediate mold in a first step, rotates the intermediate mold by 90° while leaving a molded product on the intermediate mold, thereafter assembles a plurality of molded products on the intermediate mold in a second step, then rotates the intermediate mold by 90°. The manufacturing apparatus joins the plurality of molded products thus assembled with the second mold and the intermediate mold by using molten resin in a third step, and then rotates the intermediate mold by 90°. Finally, the manufacturing apparatus discharges the plurality of molded products thus joined from the intermediate mold in a fourth step. Then, the manufacturing apparatus continuously and sequentially conducts the first step to the fourth step as described above on four surfaces of the intermediate mold while shifting the steps one after another. Since the manufacturing apparatus can conduct each step in parallel simultaneously in this way, the productivity is improved.

However, the manufacturing apparatus of the Specification of European Patent No. 1628819 is for manufacturing a plurality of products of one type, and there is no description about the molding of products of two or more types. In addition, although the manufacturing apparatus of the Specification of European Patent No. 1628819 can combine two molded components, but cannot handle more complicated molding, such as being incapable of conducting molding in which three components are combined.

### SUMMARY

Therefore, the present disclosure provides a molded product manufacturing method and a manufacturing apparatus which can conduct complicated molding.

For this purpose, a molded product manufacturing method of the present disclosure is a molded product manufacturing method using: a first mold which has a first surface; a second mold which has a second surface; and an intermediate mold which has an A surface, a B surface, a C surface, and a D surface each being capable of facing the first surface and the second surface, and which is capable of changing a surface facing the first surface and the second surface by rotating between the first mold and the second mold, the molded product manufacturing method including: a first molding step of molding a first component and a second component between the first surface and the A surface by closing the first mold and the intermediate mold and injecting molten resin into the molds in a state where the A surface is caused to face the first surface; a second molding step of molding a third component and a fourth component between the first surface and the B surface and engaging the second component with the first component held on the A surface by closing the first mold and the intermediate mold and injecting molten resin into the molds in a state where the B surface is caused to face the first surface; a third molding step of welding the first component and the second component to mold a first integral molded product and engaging the fourth component with the third component held on the B surface by closing the second mold and the intermediate mold and injecting molten resin into the molds in a state where the A surface is caused to face the second surface; and a fourth molding step of welding the third component and the fourth component to mold a second integral molded product which is different from the first integral molded product by closing the second mold and the intermediate mold and injecting molten resin into the molds in a state where the B surface is caused to face the second surface.

According to the present disclosure, it is possible to provide a molded product manufacturing method and a manufacturing apparatus which can conduct complicated molding.

Further features of the present disclosure will become apparent from the following description of exemplary embodiments with reference to the attached drawings.

### BRIEF DESCRIPTION OF THE DRAWINGS

FIG. 1 is a schematic diagram showing a manufacturing apparatus including a rotatable intermediate mold;

FIG. 2 is a schematic diagram showing a molding finished product which can be molded by the manufacturing apparatus;

FIG. 3 is an image diagram showing a molded product in which a plurality of components are assembled in a conventional manufacturing apparatus;

FIG. 4A is a schematic diagram showing the manufacturing apparatus;

FIG. 4B, FIG. 4C, FIG. 4D, and FIG. 4E are schematic diagrams showing regions on surfaces of the intermediate mold;

FIG. 5A is a side view showing the manufacturing apparatus;

FIG. 5B, FIG. 5C, and FIG. 5D are diagrams showing surfaces of molds;

FIG. 6A, FIG. 6B, FIG. 6C, and FIG. 6D are diagrams showing a molding process;

FIG. 7 is an image diagram showing a molded product;

FIG. 8A, FIG. 8B, FIG. 8C, FIG. 8D, and FIG. 8E are schematic diagrams showing a first step;

FIG. 9A, FIG. 9B, FIG. 9C, FIG. 9D, and FIG. 9E are schematic diagrams showing a second step; and

FIG. 10A, FIG. 10B, FIG. 10C, and FIG. 10D are diagrams showing a molding process in a modification.

### DESCRIPTION OF THE EMBODIMENTS

### First Embodiment

Hereinafter, a first embodiment of the present disclosure will be described with reference to the drawings.

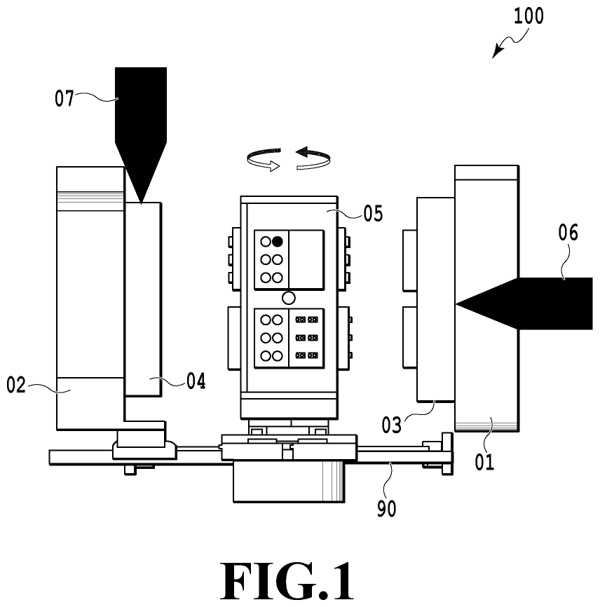

FIG. 1 is a schematic diagram showing a manufacturing apparatus 100 including a rotatable intermediate mold in the present disclosure. The manufacturing apparatus 100 includes a first mold 03, a second mold 04, and an intermediate mold 05, and the intermediate mold 05 is provided between the first mold 03 and the second mold 04. The intermediate mold 05 includes four surfaces each being capable of facing the first mold 03 and the second mold 04, and is capable of changing a surface facing the first mold 03 or the second mold 04 by rotating every 90°. The first mold 03 and the second mold 04 can each conduct molding by closing with the intermediate mold 05.

The first mold 03 is fixed to a fixed platen 01, and the fixed platen 01 is fixed to an end portion of a linear slide 90. The second mold 04 is fixed to a movable platen 02, and the movable platen 02 is supported on the linear slide 90 in such a manner as to be movable on the linear slide 90. An injection unit 06 is provided in the fixed platen 01, and the injection unit 06 injects molten resin into the first mold 03. An injection unit 07 is provided on the movable platen 02, and the injection unit 07 injects the molten resin into the second mold 04.

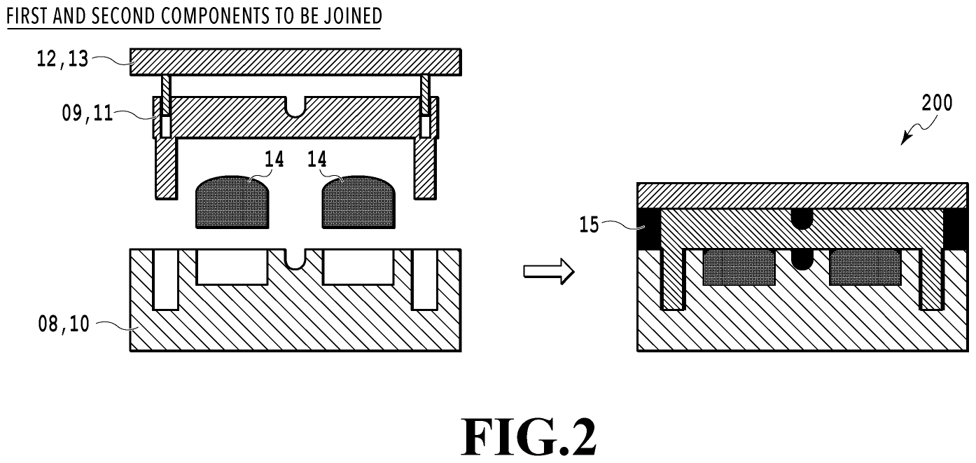

FIG. 2 is a schematic diagram showing a molding finished product 200 which can be molded by the manufacturing apparatus 100. The molding finished product 200 includes a first molded product 08, elastic members 14, a second molded product 09, and a third molded product 12. The first molded product 08, the second molded product 09, and the third molded product 12 are connected (welded). Note that it is assumed that in the manufacturing process continuously conducted in the manufacturing apparatus 100, two molding finished products having different shapes are manufactured; however, each molding finished product is molded with three molded products and one elastic member. Hence, in FIG. 2, for simplifying the description, the two molding finished products are assumed to have the same shape, and a plurality of signs are attached to a single member, like the first molded product 08, 10, the second molded product 09, 11, the third molded product 12, 13. In FIG. 2, one of these signs (the first molded product 08, the second molded product 09, and the third molded product 12) is used for description.

In the manufacturing process of the molding finished product 200, the elastic members 14 are inserted into the first molded product 08, and the second molded product 09 is mounted on the first molded product 08. Thereafter, the third molded product 12 is mounted, and molten resin 15 is poured into a space portion thus formed by the injection unit 07 to join the components. In this way, the molding finished product 200 is molded. As the molten resin 15, a material which is different from the material of the first molded product 08, the second molded product 09, and the third molded product 12 may be used, or the same material may be used.

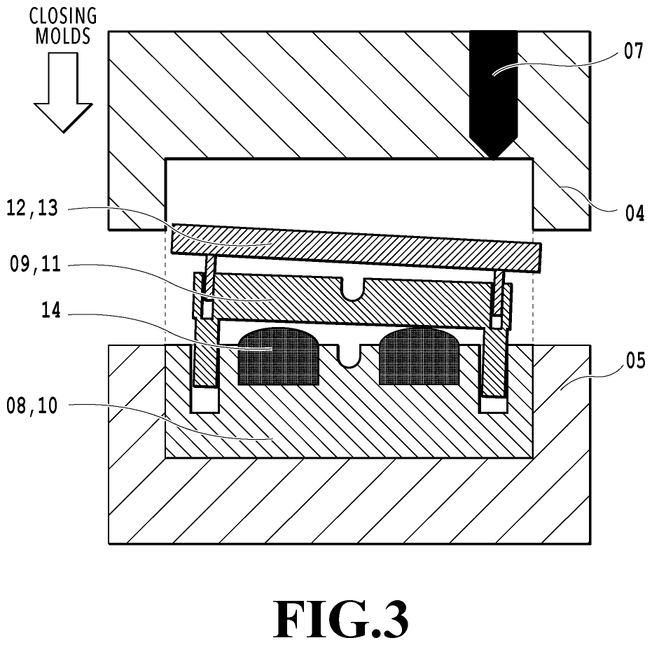

FIG. 3 is an image diagram showing how three components are assembled in the molds. FIG. 3 shows a state in which the other components are mounted on the first molded product 08 molded in the molds. Here, shown is a case where the elastic members 14, the second molded product 09, and the third molded product 12, which are the other components, are mounted on the first molded product 08 which has been molded between the first mold 03 and the intermediate mold 05 and held on the intermediate mold 05. The second molded product 09 and the third molded product 12 are components molded in molding steps, which are steps prior to the mounting. FIG. 3 shows a case where the second molded product 09 and the third molded product 12 are taken out of the molds after molding and mounted on the first molded product 08.

Abutment and assembling requires a clearance, which is unevenness for engaging the components, and the clearance contains an error region for securing the engagement. For this reason, the larger the number of components is, the larger the error accumulated is, so that there is a larger possibility that the components are displaced or inclined for the clearance at the time of assembly. In particular, inclination sometimes occur in a case of taking components out of the molds after molding and assembling the components as shown in FIG. 3. The components are fitted into the space portion in the molds by closing the molds. However, in a case where displacement or inclination is too large, there is a case where the molded product is not fitted into the space portion of the molds and is pinched by the molds, resulting in a molding failure. Hence, the present embodiment is configured such that the second molded product 09 is taken out of the molds and mounted on the first molded product 08, but the third molded product 12 is mounted on the first molded product 08 in the state of being held on the second mold 04.

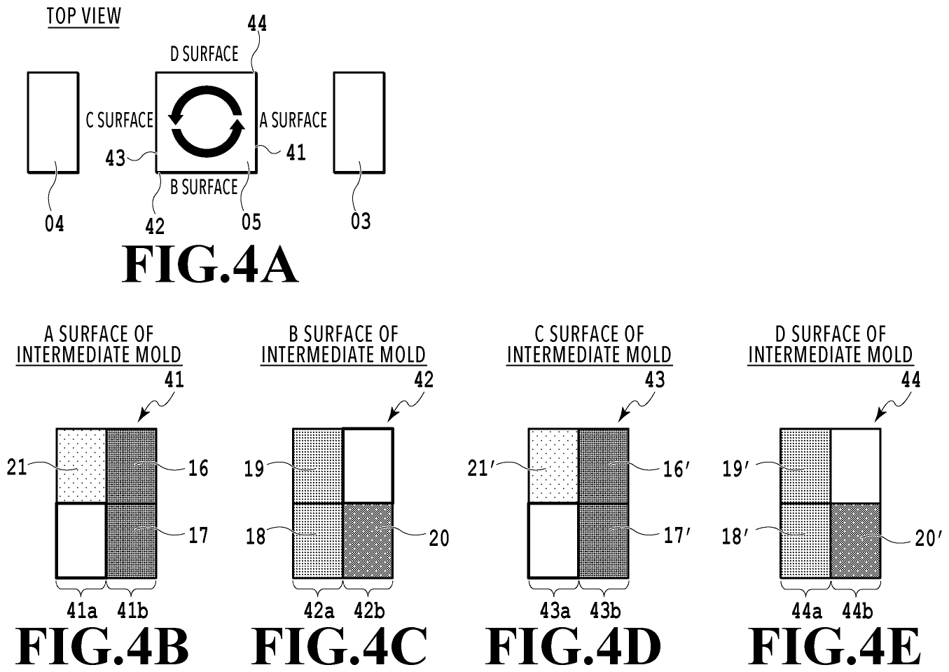

FIG. 4A is a top view showing the manufacturing apparatus 100 of the present embodiment, and FIG. 4B to FIG. 4E are schematic diagrams showing regions corresponding to two types of molding finished products on the respective surfaces of the intermediate mold 05. As shown in FIG. 4A, the intermediate mold 05 includes four surfaces, an A surface 41 to a D surface 44, and rotates by every 90 degrees. By such rotation of the intermediate mold 05, the first mold 03 and the second mold 04 are caused to face the A surface 41 (see FIG. 4B), the B surface 42 (see FIG. 4C), the C surface 43 (see FIG. 4D), and the D surface 44 (see FIG. 4E) of the intermediate mold 05 in this order.

The A surface 41 to the D surface 44 of the intermediate mold 05 includes regions for molding two types of molding finished products. The A surface 41 includes an A- surface first region 41a and an A-surface second region 41b, the B surface 42 includes a B-surface first region 42a and a B-surface second region 42b, the C surface 43 includes a C-surface first region 43a and a C-surface second region 43b, and the D surface 44 includes a D-surface first region 44a and a D-surface second region 44b. Moreover, the A-surface first region 41a includes an upper region 21, and the A-surface second region 41b includes an upper region 16 and a lower region 17. The B-surface first region 42a includes an upper region 19 and a lower region 18, and the B-surface second region 42b includes a lower region 20. The C-surface first region 43a includes an upper region 21′, and the C-surface second region 43b includes an upper region 16′ and a lower region 17′. The D-surface first region 44a includes an upper region 19′ and a lower region 18′, and the D-surface second region 44b includes a lower region 20′.

Since the intermediate mold 05 alternately molds components of each type at every 90 degrees, the A surface 41 and the C surface 43 include identical regions, and the B surface 42 and the D surface 44 include identical regions. In addition, in each region of the A surface 41 to the D surface 44, a mold piece for molding the molded product is disposed. The mold pieces are made to be capable of not only molding one molded product but also molding a plurality of identical molded products, so that a large number of mold pieces for efficiently manufacturing products can be handled.

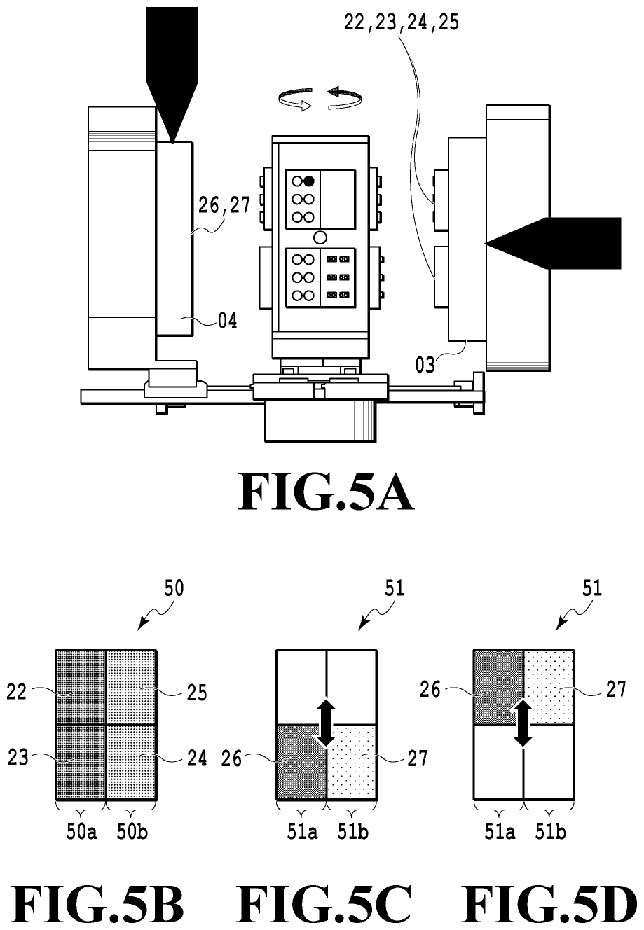

FIG. 5A is a side view showing the manufacturing apparatus 100. FIG. 5B shows a first surface 50 of the first mold 03, FIG. 5C shows a second surface 51 of the second mold 04 in the case where the mold pieces are disposed in the lower portion, and FIG. 5D shows the second surface 51 of the second mold 04 in the case where the mold pieces are disposed in the upper portion.

The first surface 50 includes a first region 50a and a second region 50b, and the first region 50a includes an upper region 22 and a lower region 23. The second region 50b includes an upper region 25 and a lower region 24. The second surface 51 includes a first region 51a and a second region 51b, and includes a region 26 which moves in an up-and-down direction in the first region 51a, and a region 27 which moves in the up- and-down direction in the second region 51b. The region 26 and the region 27 move in the state of being adjacent to each other.

The upper region 22 of the first region 50a in the first surface 50 corresponds to the upper region 16 of the A-surface second region 41b in the A surface 41 or the upper region 16′ of the C-surface second region 43b of the intermediate mold 05, and molds the first molded product 08. The lower region 23 of the first region 50a corresponds to the lower region 17 of the A-surface second region 41b in the A surface 41 or the lower region 17′ of the C-surface second region 43b of the intermediate mold 05, and molds the second molded product 09.

The upper region 25 of the second region 51b in the first surface 50 corresponds to the upper region 19 of the B-surface first region 42a in the B surface 42 or the upper region 19′ of the D-surface first region 44a of the intermediate mold 05, and molds the first molded product 10. The lower region 24 of the second region 51b corresponds to the lower region 18 of the B-surface first region 42a in the B surface 42 or the lower region 18′ of the D-surface first region 44a of the intermediate mold 05, and molds the second molded product 11.

The region 26 which moves in the first region 51a in the second surface 51 corresponds to the lower region 20 in the B-surface second region 42b or a lower region (partial region) 20′ in the D-surface second region 44b of the intermediate mold 05, and molds the third molded product 12.

The region 27 which moves in the second region 51b in the second surface 51 corresponds to the upper region 21 in the A-surface first region 41a or the upper region 21′ in the C-surface first region 43a of the intermediate mold 05, and molds the third molded product 13.

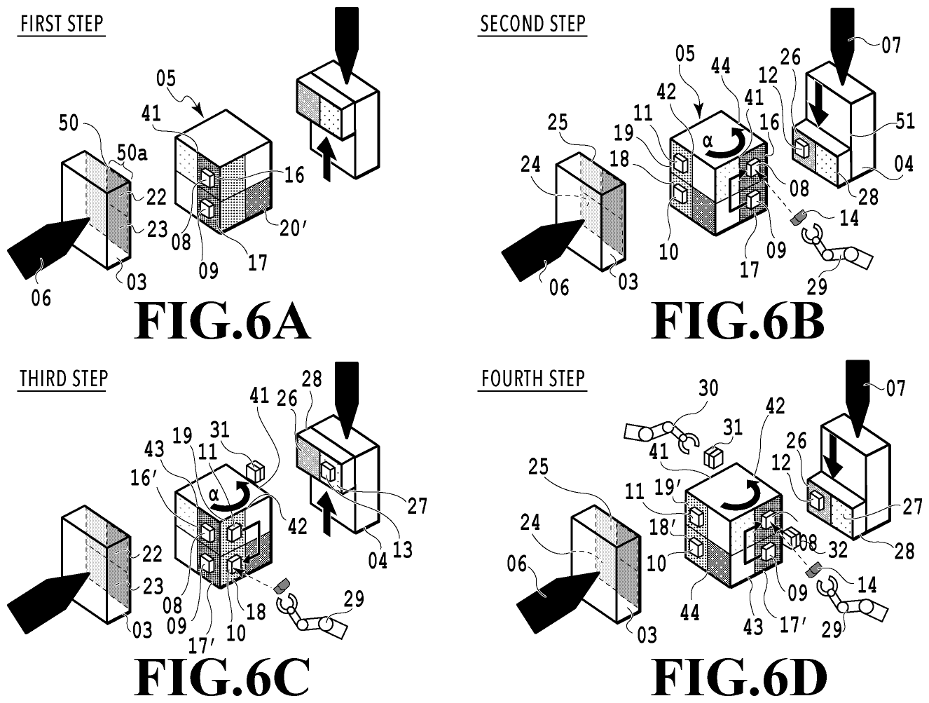

FIG. 6A to FIG. 6D are diagrams showing a molding process in the present embodiment. In the present embodiment, two types of integral molded products are alternately and repeatedly molded. Hereinafter, the molding process in the present embodiment will be described in order of steps. Note that since the molding process is continuously and simultaneously conducted, the description will be made here based on the process in the A surface 41 of the intermediate mold 05 while the other surfaces (the B surface 42, the C surface 43, and the D surface 44) are mentioned.

In a first step shown in FIG. 6A, molten resin is injected into the molds from the injection unit 06 in the state where the first mold 03 and the intermediate mold 05 have been closed. In this way, the first molded product 08 is molded between the upper region 22 of the first region 50a in the first surface 50 of the first mold 03 and the upper region 16 of the A surface 41 of the intermediate mold 05. Moreover, the second molded product 09 is molded between the lower region 23 of the first region 50a and the lower region 17 of the A-surface second region 41b of the A surface 41 of the intermediate mold 05. At the time of mold opening after the molding, the first molded product 08 and the second molded product 09 are left on the intermediate mold 05.

Here, the method for leaving a molded product on the intermediate mold 05 is such that a draft angle is provided on an outer periphery of the molded product, so that the molded product is removed from the first mold 03 and is left on the intermediate mold 05 at the time of mold opening. Note that a molded product can also be left on a mold where the molded product is desired to be left by projecting, with an ejector pin, the molded product on the opposite side to the side where the molded product is desired to be left at the time of mold opening, depending on the shape of the molded product or the configuration of the molds.

In a second step shown in FIG. 6B, after the intermediate mold 05 is rotated by 90 degrees in the direction of arrow α, elastic members 14 are inserted into the first molded product 08 molded on the upper region 16 of the A surface 41 of the intermediate mold 05 by using a first assembly robot 29. After the elastic members 14 are inserted, the second molded product 09 molded on the lower region 17 of the A surface 41 is removed from the intermediate mold 05 by using the first assembly robot 29 and moved to abut and mounted on the first molded product 08.

In addition, the molten resin is injected into the molds from the injection unit 06 in the state where the first mold 03 and the intermediate mold 05 have been closed. In this way, on the B surface 42, the first molded product 10 is molded between the lower region 24 of the second region 50b in the first mold 03 and the lower region 18 of the B surface 42 of the intermediate mold 05. Moreover, the second molded product 11 is molded between the upper region 25 of the second region 50b in the first surface 50 of the first mold 03 and the upper region 19 of the B surface 42 of the intermediate mold 05. Here, like the first step, at the time of mold opening after the molding, the first molded product 10 and the second molded product 11 are left on the intermediate mold 05.

In addition, the second mold 04 and the intermediate mold 05 are closed in the state where a first mold piece 28 has been disposed in the lower portion on the second surface 51 of the second mold 04, and the molten resin is injected into the molds from the injection unit 07. In this way, the third molded product 12 is molded between the lower region 20′ of the D surface 44 of the intermediate mold 05 and the region 26.

At this time, the third molded product 12 is left on the second mold 04 at the time of mold opening. The method for leaving a molded product on the second mold 04 is the same as the above-mentioned method for leaving a molded product on the intermediate mold 05. The first mold piece 28 changes its position in the up-and-down direction to change the region corresponding to the intermediate mold 05 every time the intermediate mold 05 is rotated by 90°.

In a third step shown in FIG. 6C, the intermediate mold 05 is rotated by 90° in the direction of arrow α. The first mold piece 28 moves to the upper portion of the second mold 04. This causes the upper region 16 of the A surface 41 of the intermediate mold 05 on which the first molded product 08 and the second molded product 09 have been disposed and the region 26 of the second mold 04 on which the third molded product 12 has been disposed to face each other. After the rotation, by injecting the molten resin from the injection unit 07 in the state where the second mold 04 and the intermediate mold 05 have been closed, the first molded product 08, the second molded product 09, and the third molded product 12 are joined, so that a first integral molded product 31, which becomes a molding finished product, is molded. In addition, the third molded product 13 is molded between the region 27 disposed in the upper portion of the second mold 04 and the upper region 21 of the A surface 41 of the intermediate mold 05.

On the B surface 42, the elastic members 14 are inserted into the first molded product 10 by using the first assembly robot 29. After the elastic members 14 are inserted, the second molded product 11 molded on the upper region 19 of the B surface 42 is removed from the intermediate mold 05 by using the first assembly robot 29 and moved to abut and mounted on the first molded product 10.

In addition, the molten resin is injected into the molds from the injection unit 06 in the state where the first mold 03 and the intermediate mold 05 have been closed. In this way, on the C surface 43, the first molded product 08 is molded between the upper region 22 of the first region 50a in the first surface 50 of the first mold 03 and the upper region 16′ of the C surface 43 of the intermediate mold 05. Moreover, the second molded product 09 is molded between the lower region 23 of the first region 50a and the lower region 17′ of the C surface 43 of the intermediate mold 05. At the time of mold opening after the molding, the first molded product 08 and the second molded product 09 are left on the intermediate mold 05.

In a fourth step shown in FIG. 6D, after the intermediate mold 05 is rotated by 90° in the direction of arrow α, on the A surface 41, the first integral molded product 31 is taken out by using a second assembly robot 30.

By injecting the molten resin into the molds from the injection unit 07 in the state where the second mold 04 and the intermediate mold 05 have been closed, on the B surface 42, the third molded product 12 is molded between the region 26 which has been moved to the lower portion of the second mold 04 and the lower region 20 of the B surface 42 of the intermediate mold 05. In addition, the first molded product 10, the second molded product 11, and the third molded product 13 are joined between the lower region 18 in the B-surface first region 42a of the intermediate mold 05 and the region 27 which has been disposed in the lower portion of the second mold 04, so that a second integral molded product 32, which becomes a molding finished product, is molded.

On the C surface 43, the elastic members 14 are inserted into the first molded product 08 molded on the upper region 16 of the A surface 41 of the intermediate mold 05 by using the first assembly robot 29. After the elastic members 14 are inserted, the second molded product 09 molded on the lower region 17′ of the C surface 43 is removed from the intermediate mold 05 by using the first assembly robot 29 and moved to abut and mounted on the first molded product 08.

On the D surface 44, the molten resin is injected into the molds from the injection unit 06 in the state where the first mold 03 and the intermediate mold 05 have been closed. In this way, the first molded product 10 is molded between the lower region 24 of the second region 50b in the first mold 03 and the lower region 18′ of the D surface 44 of the intermediate mold 05. Moreover, the second molded product 11 is molded between the upper region 25 of the second region 50b in the first surface 50 of the first mold 03 and the upper region 19′ of the D surface 44 of the intermediate mold 05. Here, as well, the first molded product 10 and the second molded product 11 are left on the intermediate mold 05 at the time of mold opening after the molding.

By repeating such a series of processes, two types of integral molded products in each of which three components are combined can be alternately molded.

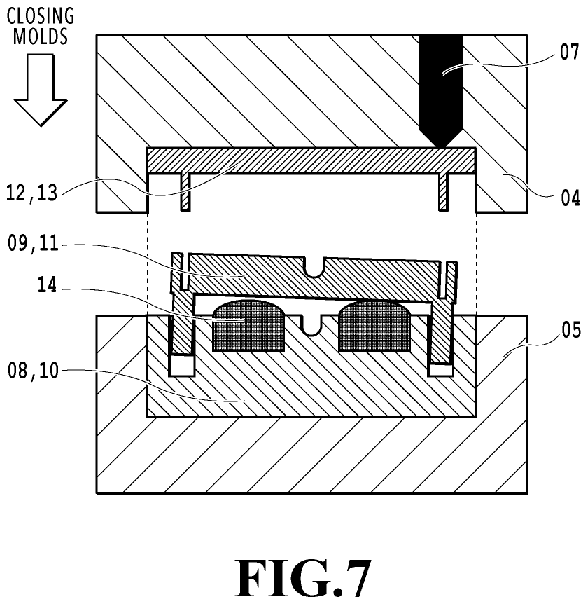

FIG. 7 is an image diagram showing molded products (the first integral molded product 31 and the second integral molded product 32) molded in the third step of FIG. 6C and fourth step of FIG. 6D. Here, the third step is described as an example.

In the third step, the third molded product 12 is combined with the assembled first molded product 08 and second molded product 09 to mold the first integral molded product 31. At this time, the third molded product 12 is not taken out of the second mold 04 and is combined with the first molded product 08 and the second molded product 09 assembled in the intermediate mold 05 to mold the first integral molded product 31. By not taking the third molded product 12 out of the second mold 04, it becomes possible to assemble the molded products without inclination or misalignment.

As shown in FIG. 7, since the second molded product 09 mounted on the first molded product 08 in the second step is taken out of the mold at the time of the molding, and is mounted by using the first assembly robot 29, there is a case where the second molded product 09 is mounted while being inclined. However, after that, by mounting the third molded product 12 without being taken out of the second mold 04, the first integral molded product 31 can be molded in the state where the inclination of the second molded product 09 has been corrected. That is, according to the present embodiment, it is possible to suppress misalignment or inclination of components in a clearance and to thus improve the yield of molding finished products as compared with the method in which the second molded product 09 and the third molded product 12 are taken out of the molds where the second molded product 09 and the third molded product 12 have been mold, and are mounted on the first molded product 08 as explained in FIG. 3.

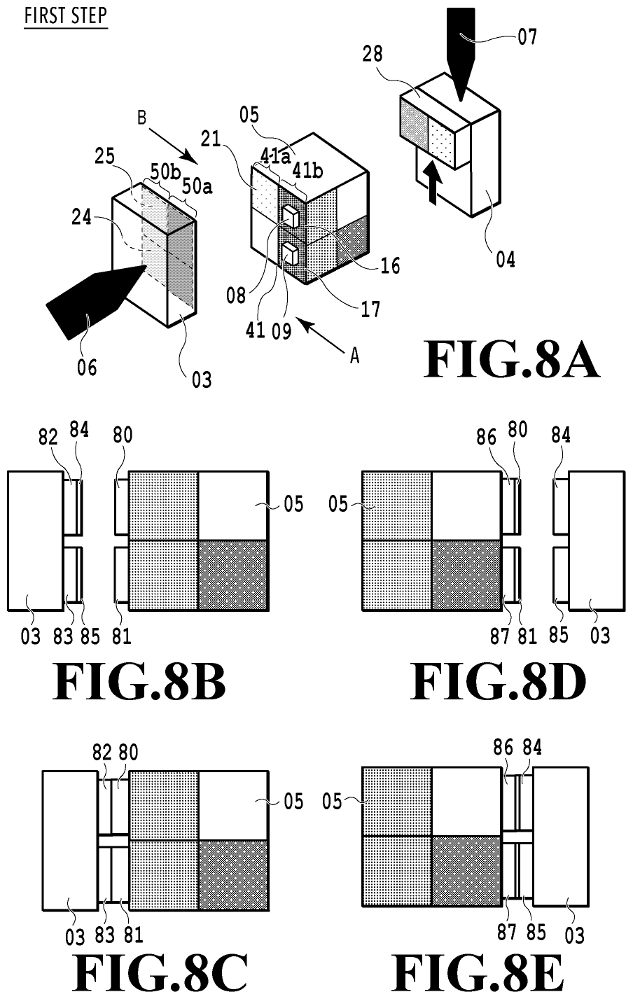

FIG. 8A to FIG. 8E are schematic diagrams showing the first mold 03, the intermediate mold 05, and the second mold 04 in the first step (see FIG. 6A). Note that FIG. 8A is shown without mold pieces.

In the first step, the first molded product 08 is molded between the upper region 22 of the first region 50a in the first surface 50 of the first mold 03 and the upper region 16 of the A surface 41 of the intermediate mold 05 by using the injection unit 06 as described above. Moreover, the second molded product 09 is molded between the lower region 23 of the first region 50a and the lower region 17 of the A-surface second region 41b of the A surface 41 of the intermediate mold 05 by using the injection unit 06.

At this time, the lower region 24 of the second region 50b in the first mold 03 and the upper region 25 of the second region 50b in the first mold 03 do not correspond to the A-surface first region 41a (including the upper region 21) of the A surface 41 of the intermediate mold 05 facing them in terms of mold pieces. Specifically, the second region 50b of the first mold 03 is a mold piece for molding the first molded product 10 and the second molded product 11 of the second integral molded product 32. However, the upper region 21 of the A surface 41 of the intermediate mold 05 facing this is a mold piece for molding the third molded product 13 of the second integral molded product 32. For this reason, the present embodiment is configured such that at the time of mold closing, the mold pieces do not interfere with each other. Specifically, the mold piece of the second region 50b of the first mold 03 is caused to protrude in the direction of mold closing more than the mold piece of the first region 50a. In addition, in the A surface 41 of the intermediate mold 05, the mold piece of the second region 41b is caused to protrude in the direction of mold closing more than the mold piece of the first region 41a. Then, in the case where the first mold 03 and the intermediate mold 05 are closed in the state where the A surface 41 of the intermediate mold 05 faces the first mold 03, the mold piece of the first region 50a of the first mold 03 and the mold piece of the second region 41b of the intermediate mold 05 abut on each other. However, the mold piece of the second region 50b of the first mold 03 and the mold piece (non-corresponding mold pieces) of the first region 41a of the intermediate mold 05 are in the state of being separated from each other. The detail will be described below.

FIG. 8B is a diagram showing the first mold 03 and the intermediate mold 05 at the time of mold opening as viewed in the direction of arrow A, and FIG. 8C is a diagram showing the first mold 03 and the intermediate mold 05 at the time of mold closing as viewed in the direction of arrow A. In FIG. 8B, an upper mold piece 82 and a lower mold piece 83 in the first region 50a of the first mold 03 and an upper mold piece 84 and a lower mold piece 85 in the second region 50b thereof can be seen.

As shown in FIG. 8C, at the time of mold closing, the upper mold piece 82 in the first region 50a of the first mold 03 and an upper mold piece 80 in the A-surface second region 41b of the intermediate mold 05 are combined to mold the first molded product 08. In addition, the lower mold piece 83 in the first region 50a of the first mold 03 and the lower mold piece 81 in the A-surface second region 41b of the intermediate mold 05 are combined to mold the second molded product 09.

FIG. 8D is a diagram showing the first mold 03 and the intermediate mold 05 at the time of mold opening as viewed in the direction of arrow B, and FIG. 8E is a diagram showing the first mold 03 and the intermediate mold 05 at the time of mold closing as viewed in the direction of arrow B. In FIG. 8D, an upper mold piece 86 and a lower mold piece 87 in the A-surface first region 41a of the intermediate mold 05 and an upper mold piece 80 and the lower mold piece 81 in the A-surface second region 41b of the intermediate mold 05 can be seen.

As shown in FIG. 8E, at the time of mold closing, the upper mold piece 84 in the second region 50b of the first mold 03 and the upper mold piece 86 in the A-surface first region 41a of the intermediate mold 05 are not engaged with each other. In addition, the lower mold piece 85 in the second region 50b of the first mold 03 and the lower mold piece 87 in the A-surface first region 41a of the intermediate mold 05 are not engaged with each other.

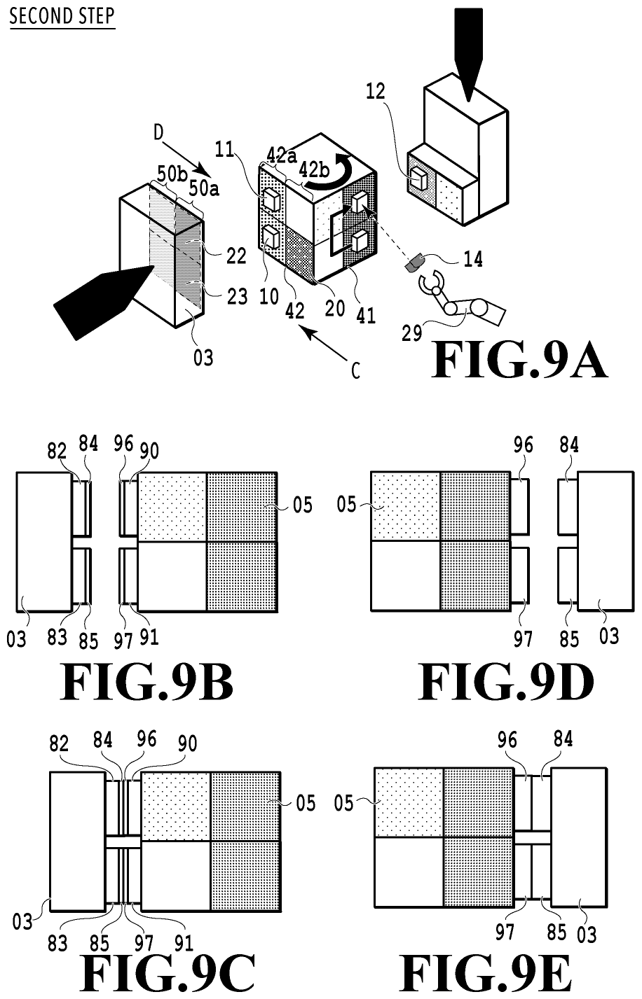

FIG. 9A to FIG. 9E are schematic diagrams showing the first mold 03, the intermediate mold 05, and the second mold 04 in the second step (see FIG. 6B). Note that FIG. 9A is shown without mold pieces.

In the second step, the first molded product 10 is molded between the lower region 24 of the second region 50b of the first mold 03 and the lower region 18 of the B surface 42 of the intermediate mold 05 by using the injection unit 06 as described above. Moreover, the second molded product 11 is molded between the upper region 25 of the second region 50b in the first surface 50 of the first mold 03 and the upper region 19 of the B surface 42 of the intermediate mold 05 by using the injection unit 06.

At this time, the lower region 23 of the first region 50a in the first mold 03 and the upper region 22 of the first region 50a in the first mold 03 do not correspond to the B- surface second region 42b (including the lower region 20) of the B surface 42 of the intermediate mold 05 facing them in terms of mold pieces. For this reason, the present embodiment is configured such that at the time of mold closing, the mold pieces do not interfere with each other. Specifically, the mold piece of the second region 50b of the first mold 03 is caused to protrude in the direction of mold closing more than the mold piece of the first region 50a as described above. In addition, in the B surface 42 of the intermediate mold 05, the mold piece of the first region 42a is caused to protrude in the direction of mold closing more than the mold piece of the second region 41b. Then, in the case where the first mold 03 and the intermediate mold 05 are closed in the state where the B surface 42 of the intermediate mold 05 faces the first mold 03, the mold piece of the second region 50b of the first mold 03 and the mold piece of the first region 41a of the intermediate mold 05 abut on each other. However, the mold piece of the first region 50a of the first mold 03 and the mold piece of the second region 41b of the intermediate mold 05 are in the state of being separated from each other. The detail will be described below.

FIG. 9B is a diagram showing the first mold 03 and the intermediate mold 05 at the time of mold opening as viewed in the direction of arrow C, and FIG. 9C is a diagram showing the first mold 03 and the intermediate mold 05 at the time of mold closing as viewed in the direction of arrow C. In FIG. 9B, the upper mold piece 82 and the lower mold piece 83 in the first region 50a of the first mold 03 and the upper mold piece 84 and the lower mold piece 85 in the second region 50b can be seen. In addition, the upper mold piece 90 and the lower mold piece 91 in the B-surface second region 42b of the B surface 42 of the intermediate mold 05 and the upper mold piece 96 and the lower mold piece 97 in the B-surface first region 42a thereof can be seen.

As shown in FIG. 9C, at the time of mold closing, the upper mold piece 84 in the second region 50b of the first mold 03 and the upper mold piece 96 in the B-surface first region 42a of the intermediate mold 05 are combined to mold the second molded product 11. In addition, the lower mold piece 85 in the second region 50b of the first mold 03 and the lower mold piece 97 in the B-surface first region 42a of the intermediate mold 05 are combined to mold the first molded product 10. At this time, the upper mold piece 82 in the first region 50a of the first mold 03 and the upper mold piece 90 in the B-surface second region 42b of the B surface 42 of the intermediate mold 05 are not engaged with each other. In addition, the lower mold piece 83 in the first region 50a of the first mold 03 and the lower mold piece 91 in the B-surface second region 42b of the B surface 42 of the intermediate mold 05 are also not engaged with each other.

FIG. 9D is a diagram showing the first mold 03 and the intermediate mold 05 at the time of mold opening as viewed in the direction of arrow D, and FIG. 9E is a diagram showing the first mold 03 and the intermediate mold 05 at the time of mold closing as viewed in the direction of arrow D. In FIG. 9D, the upper mold piece 96 and the lower mold piece 97 in the B-surface first region 42a and the upper mold piece 84 and the lower mold piece 85 in the second region 50b of the first mold 03 can be seen.

As shown in FIG. 9E, at the time of mold closing, the upper mold piece 96 in the B-surface first region 42a and the upper mold piece 84 in the second region 50b of the first mold 03 are combined. In addition, the lower mold piece 97 in the B-surface first region 42a and the lower mold piece 85 in the second region 50b of the first mold 03 are combined. In this way, in the situation where mold pieces which do not correspond to each other face each other, the positions of the mold surfaces in the direction of mold opening and closing are appropriately displaced so that the mold pieces should not interfere with each other at the time of mold closing.

In this way, the first mold 03 is divided into the first region 50a and the second region 50b, and each surface of the A surface to the D surface of the intermediate mold 05 is divided into the first region and the second region. Moreover, in the second mold 04, the mold piece is configured to be movable between the upper portion (first position) and the lower portion (second position). This makes it possible to provide a molded product manufacturing method and a manufacturing apparatus which are capable of conducting more complicated molding

### Modification

Hereinafter, a modification of the first embodiment of the present disclosure will be described with reference to the drawings.

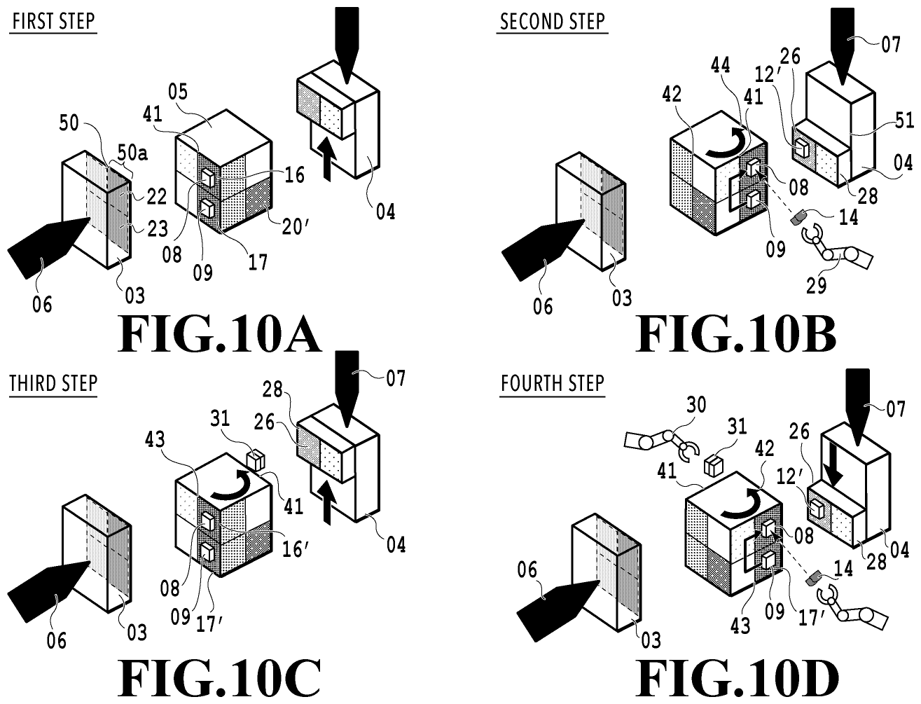

FIG. 10A to FIG. 10D are diagrams showing a molding process in the modification. In contrast to the first embodiment which is capable of alternately and repeatedly molding two types of integral molded products, the present modification repeatedly molds one type of integral molded products. Hereinafter, the molding process in the present embodiment will be described in order of steps. Note that since the molding process is continuously and simultaneously conducted, the description will be made here based on the process in the A surface 41 of the intermediate mold 05 while the other surfaces (the B surface 42, the C surface 43, and the D surface 44) are mentioned.

In a first step shown in FIG. 10A, the molten resin is injected into the molds from the injection unit 06 in the state where the first mold 03 and the intermediate mold 05 have been closed. In this way, the first molded product 08 is molded between the upper region 22 of the first region 50a in a first surface 50 of the first mold 03 and an upper region 16 of the A surface 41 of the intermediate mold 05. Moreover, the second molded product 09 is molded between the lower region 23 of the first region 50a and the lower region 17 of the A-surface second region 41b of the A surface 41 of the intermediate mold 05. At the time of mold opening after the molding, the first molded product 08 and the second molded product 09 are left on the intermediate mold 05.

In a second step shown in FIG. 10B, after the intermediate mold 05 is rotated by 90 degrees in the direction of arrow α, the elastic members 14 are inserted into the first molded product 08 molded on the upper region 16 of the A surface 41 of the intermediate mold 05 by using the first assembly robot 29. After the elastic members 14 are inserted, the second molded product 09 molded on the lower region 17 of the A surface 41 is removed from the intermediate mold 05 by using the first assembly robot 29 and moved to abut and mounted on the first molded product 08.

On the D surface 44, the molten resin is injected into the molds from the injection unit 07 in the state where the second mold 04 and the intermediate mold 05 have been closed. In this way, a third molded product 12′ is molded between the region 26 in the case where the first mold piece 28 is disposed in the lower portion on the second surface 51 of the second mold 04 and the lower region 20′ of the D surface 44 of the intermediate mold 05.

At this time, the third molded product 12′ is left on the second mold 04 at the time of mold opening. The first mold piece 28 changes its position in the up-and-down direction to change the region corresponding to the intermediate mold 05 every time the intermediate mold 05 is rotated by 90°.

In a third step shown in FIG. 10C, the intermediate mold 05 is rotated by 90° in the direction of arrow α. Then, the molten resin is injected into the molds from the injection unit 07 in the state where the second mold 04 and the intermediate mold 05 have been closed. In this way, the third molded product 12′ is combined with the mounted first molded product 08 and second molded product 09 by using the upper region 16 in the A-surface second region 41b of the intermediate mold 05 and the region 26 in the case where the first mold piece 28 is disposed in the upper portion in the second mold 04 to mold the first integral molded product 31.

On the C surface 43, the molten resin is injected into the molds from the injection unit 06 in the state where the first mold 03 and the intermediate mold 05 have been closed. In this way, the first molded product 08 is molded between the upper region 22 of the first region 50a in the first surface 50 of the first mold 03 and the upper region 16′ of the C surface 43 of the intermediate mold 05. Moreover, the second molded product 09 is molded between the lower region 23 of the first region 50a and the lower region 17′ of the C surface 43 of the intermediate mold 05. At the time of mold opening after the molding, the first molded product 08 and the second molded product 09 are left on the intermediate mold 05.

In a fourth step shown in FIG. 10D, after the intermediate mold 05 is rotated by 90° in the direction of arrow α, on the A surface 41, the first integral molded product 31 is taken out by using the second assembly robot 30.

The molten resin is injected into the molds from the injection unit 07 in the state where the second mold 04 and the intermediate mold 05 have been closed. In this way, on the B surface 42, the third molded product 12′ is molded between the region 26 in the case where the first mold piece 28 is disposed in the lower portion on the second surface 51 of the second mold 04 and the lower region 20 of the B surface 42 of the intermediate mold 05.

On the C surface 43, the elastic members 14 are inserted into the first molded product 08 molded on the upper region 16 of the A surface 41 of the intermediate mold 05 by using the first assembly robot 29. After the elastic members 14 are inserted, the second molded product 09 molded on the lower region 17′ of the C surface 43 is removed from the intermediate mold 05 by using the first assembly robot 29 and moved to abut and mounted on the first molded product 08.

In this way, one type of integral molded products can be repeatedly molded by the method of the present modification.

### Other Embodiments

Although in the first embodiment, the configuration in which the first integral molded product 31 and the second integral molded product 32 are each obtained by molding and combining the first molded product, the second molded product, and the third molded product has been described as an example, the configuration is not limited to this. A configuration is possible in which a third molded product is not molded, and a first molded product and a second molded product are molded and combined to mold an integral molded product. That is, the first integral molded product 31 may be configured to include the first molded product 08 and the second molded product 09 while not including the third molded product 12, and the second integral molded product 32 may be configured to include the first molded product 10 and the second molded product 11 while not including the third molded product 13.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-012787, filed Jan. 31, 2024, which is hereby incorporated by reference wherein in its entirety.

What is claimed is:

1. A molded product manufacturing method using:
a first mold which has a first surface;
a second mold which has a second surface; and
an intermediate mold which has an A surface, a B surface, a C surface, and a D surface each being capable of facing the first surface and the second surface, and which is capable of changing a surface facing the first surface and the second surface by rotating between the first mold and the second mold,
the molded product manufacturing method comprising:
a first molding step of molding a first component and a second component between the first surface and the A surface by closing the first mold and the intermediate mold and injecting molten resin into the molds in a state where the A surface is caused to face the first surface;
a second molding step of molding a third component and a fourth component between the first surface and the B surface and engaging the second component with the first component held on the A surface by closing the first mold and the intermediate mold and injecting molten resin into the molds in a state where the B surface is caused to face the first surface;
a third molding step of welding the first component and the second component to mold a first integral molded product and engaging the fourth component with the third component held on the B surface by closing the second mold and the intermediate mold and injecting molten resin into the molds in a state where the A surface is caused to face the second surface; and
a fourth molding step of welding the third component and the fourth component to mold a second integral molded product which is different from the first integral molded product by closing the second mold and the intermediate mold and injecting molten resin into the molds in a state where the B surface is caused to face the second surface.

2. The molded product manufacturing method according to claim 1, wherein
a mold piece of the C surface is identical to a mold piece of the A surface, and a mold piece of the D surface is identical to a mold piece of the B surface,
in the second molding step, a fifth component is molded between the second surface and the D surface by closing the second mold and the intermediate mold and injecting molten resin into the molds formed by a first region of the second surface and a partial region of the D surface in a state where the D surface is caused to face the second surface,
in the third molding step, the first component and the second component are molded between the first surface and the C surface by closing the first mold and the intermediate mold and injecting molten resin into the molds in a state where the C surface is caused to face the first surface, and moreover, the first component, the second component, and the fifth component are welded to mold the first integral molded product by closing the second mold and the intermediate mold and injecting molten resin into the molds in a state where the A surface which holds the first component and the second component engaged with each other in the second molding step is caused to face the second surface which holds the fifth component molded in the second molding step,
in the fourth molding step, the third component and the fourth component are molded between the first surface and the D surface by closing the first mold and the intermediate mold and injecting molten resin into the molds in a state where the D surface is caused to face the first surface, and
in the fourth molding step, the first integral molded product is removed from the intermediate mold.

3. The molded product manufacturing method according to claim 2, wherein in the second surface, the first region and a second region which is adjacent to the first region are capable of moving to a first position and to a second position in a state of being adjacent to each other.

4. The molded product manufacturing method according to claim 3, wherein the first region and the second region move in conjunction with the rotation of the intermediate mold.

5. The molded product manufacturing method according to claim 1, wherein
in the second molding step, the second component is engaged with the first component by a robot, and
in the third molding step, the fourth component is engaged with the second component by the robot.

6. The molded product manufacturing method according to claim 5, wherein
in the second molding step, the robot inserts a first member between the first component and the second component, and
in the third molding step, the robot inserts a second member between the third component and the fourth component.

7. The molded product manufacturing method according to claim 6, wherein the first member and the second member are elastic members.

8. The molded product manufacturing method according to claim 1, wherein
the resin for welding the first component and the second component in the third molding step is a resin which is different from a material of the first component and the second component, and
the resin for welding the third component and the fourth component in the fourth molding step is a resin which is different from a material of the third component and the fourth component.

9. A molded product manufacturing method using:
a first mold which has a first surface;
a second mold which has a second surface; and
an intermediate mold which has an A surface, a B surface, a C surface, and a D surface each being capable of facing the first surface and the second surface, and which is capable of changing a surface facing the first surface and the second surface by rotating between the first mold and the second mold,
the molded product manufacturing method comprising:
a first molding step of molding a first component and a second component between the first mold and the first surface by closing the first mold and the intermediate mold and injecting molten resin into the molds in a state where the first surface is caused to face the first mold;
a second molding step of molding a fifth component between the second surface and the D surface and engaging the second component with the first component held on the A surface by closing the second mold and the intermediate mold and injecting molten resin into the molds in a state where the D surface is caused to face the second surface; and
a third molding step of welding the first component, the second component, and the fifth component to mold a first integral molded product by closing the second mold and the intermediate mold and injecting molten resin into the molds in a state where the A surface which holds the first component and the second component engaged with each other in the second molding step is caused to face the second surface which holds the fifth component molded in the second molding step.

10. The molded product manufacturing method according to claim 9, wherein
in the second molding step, a third component and a fourth component are molded between the first surface and the B surface by closing the first mold and the intermediate mold and injecting molten resin into the molds in a state where the B surface is caused to face the first surface,
in the third molding step, a sixth component is further molded between the first surface and the A surface and engaging the fourth component with the third component held on the B surface by closing the first mold and the intermediate mold and injecting molten resin into the molds in the state where the A surface is caused to face the second surface,
the molded product manufacturing method further comprises
a fourth molding step of welding the third component, the fourth component, and the sixth component to mold a second integral molded product which is different from the first integral molded product by closing the second mold and the intermediate mold and injecting molten resin into the molds in a state where the B surface which holds the third component and the fourth component engaged with each other in the third molding step is caused to face the second surface which holds the sixth component molded in the third molding step, and
in the fourth molding step, the first integral molded product is removed from the intermediate mold.

11. A manufacturing apparatus comprising:
a first mold which is connected to a first injection unit for injecting a resin and has a first surface;
a second mold which is connected to a second injection unit for injecting a resin and has a second surface; and
an intermediate mold which is provided between the first mold and the second mold and has four surfaces of an A surface, a B surface, a C surface, and a D surface each being capable of facing the first surface and the second surface, wherein
on the first surface and the A surface, mold pieces which are capable of molding a first component and a second component by being closed in a state of being caused to face each other, through injection of molten resin from the first injection unit are disposed,
on the first surface and the B surface, mold pieces which are capable of molding a third component and a fourth component by being closed in a state of being caused to face each other, through injection of molten resin from the first injection unit are disposed,
on the second surface, a mold piece which is capable of welding the first component and the second component to mold a first integral molded product by being closed in a state of being caused to face the A surface, through injection of the molten resin from the second injection unit is disposed, and
on the second surface, a mold piece which is capable of welding the third component and the fourth component to mold a second integral molded product which is different from the first integral molded product by being closed in a state of being caused to face the B surface, through injection of the molten resin from the second injection unit is disposed.

12. The manufacturing apparatus according to claim 11, wherein
on the second surface and the D surface, mold pieces which are capable of molding a fifth component by being closed in a state of being caused to face each other through injection of the molten resin into the molds are disposed, and
on the second surface which holds the fifth component and the A surface, mold pieces which are capable of welding the first component, the second component, and the fifth component to mold a first integral molded product by being closed in a state where the A surface which holds the first component and the second component engaged with each other and the second surface are caused to face each other, through injection of molten resin into the molds, are disposed.

13. The manufacturing apparatus according to claim 12, wherein
on the first surface and the A surface, mold pieces which are closed and mold the first component and the second component and non-corresponding mold pieces which are not closed and are separated, in a case of being closed in a state of being caused to face each other, are disposed.

14. The manufacturing apparatus according to claim 12, wherein
on the second surface and the A surface, mold pieces which are capable of molding a sixth component by being closed in a state of being caused to face each other through injection of the molten resin into the molds are disposed, and
on the second surface which holds the sixth component and the A surface, mold pieces which are capable of welding the third component, the fourth component, and the sixth component to mold a third integral molded product by being closed in a state where the B surface which holds the third component and the fourth component engaged with each other and the second surface are caused to face each other, through injection of molten resin into the molds, are disposed.
